(19) United States
(12) Patent Application Publication
(10) Pub. No.: US 2014/0256250 A1
(43) Pub. Date: Sep. 11, 2014

(54) PEER-TO-PEER DATA TRANSFER USING NEAR FIELD COMMUNICATION (NFC)-ENABLED STYLUSES

(71) Applicant: BARNESANDNOBLE.COM LLC, New York, NY (US)

(72) Inventors: Gerald B. Cueto, San Jose, CA (US); Dale J. Brewer, San Marcos, CA (US)

(73) Assignee: barnesandnoble.com llc, New York, NY (US)

(21) Appl. No.: 13/793,330

(22) Filed: Mar. 11, 2013

(51) Int. Cl. H04B 5/00

(52) U.S. Cl. CPC H04B 5/0031
USPC 455/41.1

(57) ABSTRACT

Peer-to-peer data transfer techniques using near field communication (NFC)-enabled styluses are disclosed. The styluses are intended for use with an electronic touch sensitive device. A first data transfer technique is through stylus NFC sharing, where the NFC wireless connection is used to allow peer-to-peer data transfer between the NFC-enabled stylus and another NFC-enabled device. A second data transfer technique is through stylus NFC pairing, where the NFC-enabled stylus is used to establish a more capable wireless connection Bluetooth-based or Wi-Fi-based), which can then be used to allow peer-to-peer data transfer with another NFC-enabled device. The stylus NFC pairing may pair the other NFC-enabled device to either the stylus or a related touch sensitive device. These techniques allow for peer-to-peer transfer of data such as documents, presentations, lectures, notes, or photos, for example.

### FIELD OF THE DISCLOSURE

This disclosure relates to styluses for touch sensitive devices, and more particularly, to peer-to-peer data transfer using near field communication (NFC)-enabled styluses.

### BACKGROUND

Electronic touch sensitive devices such as tablets, eReaders, mobile phones, smart phones, personal digital assistants (PDAs), and other such devices are commonly used for providing digital content. The content may be, for example, an e-book, an online website, images, documents, notes, or various audio or video content, just to name a few types. Such devices sometimes use or include a display, which is useful for displaying a user interface that allows a user to interact with the digital content. The user may interact with the touch sensitive computing device using fingers and/or a stylus, for example. The use of a stylus may enhance the user's experience when interacting with the touch sensitive device. For example, using a stylus may increase the user's input accuracy or comfort, especially when writing or drawing on a touch sensitive electronic device.

### BRIEF DESCRIPTION OF THE DRAWINGS

FIGS. 1a-b illustrate an example electronic touch sensitive device capable of being used for stylus data transfer functionality, in accordance with an embodiment of the present invention.

FIG. 1c illustrates an example near field communication (NFC)-enabled stylus for use with an electronic touch sensitive device, in accordance with an embodiment of the present invention.

FIGS. 1d-e illustrate example configuration screen shots of the electronic touch sensitive device shown in FIGS. 1a-b, configured in accordance with an embodiment of the present invention.

FIG. 2a illustrates a block diagram of an electronic touch sensitive device, configured in accordance with an embodiment of the present invention.

FIG. 2b illustrates a block diagram of a communication system including the electronic touch sensitive device of FIG. 2a, configured in accordance with an embodiment of the present invention.

FIG. 2c illustrates a block diagram of an example NFC-enabled stylus for use with an electronic touch sensitive device, configured in accordance with an embodiment of the present invention.

FIG. 2d illustrates a block diagram showing a communication link between the electronic touch sensitive device of FIG. 2a and the stylus of FIG. 2, according to an embodiment of the present invention.

FIGS. 3a-c illustrate an example stylus NFC sharing function using an NFC-enabled stylus, in accordance with an embodiment of the present invention.

FIGS. 4a-c illustrate an example stylus NFC pairing to stylus function using an NFC-enabled stylus, in accordance with an embodiment of the present invention.

FIGS. 5a-c illustrate an example stylus NFC pairing to related touch sensitive device function using an NFC-enabled stylus, in accordance with an embodiment of the present invention.

FIG. 6 illustrates a method for stylus data transfer using an NFC-enabled stylus, in accordance with one or more embodiments of the present invention.

### DETAILED DESCRIPTION

Peer-to-peer data transfer techniques using near field communication (NFC)-enabled styluses are disclosed. The styluses are intended for use with an electronic touch sensitive device. A first data transfer technique is through stylus NFC sharing, where the NFC wireless connection is used to allow peer-to-peer data transfer between the NFC-enabled stylus and another NFC-enabled device. A second data transfer technique is through stylus NFC pairing, where the NFC-enabled stylus is used to establish a more capable wireless connection (e.g., Bluetooth-based or Wi-Fi-based), which can then be used to allow peer-to-peer data transfer with another NFC-enabled device. The stylus NFC pairing may pair the other NFC-enabled device to either the stylus or a related touch sensitive device. These techniques allow for peer-to-peer transfer of data such as documents, presentations, lectures, notes, or photos, for example. Numerous variations and configurations will be apparent in light of this disclosure.

General Overview

Near field communication (NFC) is a set of standards for short-range wireless technologies that enable two nearby devices to communicate with each other wirelessly. Although NFC can be used in different operating modes, this disclosure is primarily concerned with the peer-to-peer NFC operating mode for the purposes of data transfer (where all NFC-enabled devices described herein operate in active NFC mode). For example, and in accordance with various embodiments of the present invention, techniques are disclosed for transferring data using NFC-enabled styluses. The data may be transferred to, for example, another NFC-enabled stylus or an NFC-enabled computing device (e.g., laptop or tablet or mobile phone or cloud-portal device). The type of data that can be transferred may include, for example, documents, presentations or lectures, notes, messages, photos, audio files, videos, contact information, applications, games, uniform resource locators (URLs), website links, and/or stylus customizations, as well as other digital data.

As will be apparent in light of this disclosure, the NFC-enabled styluses disclosed herein allow peer-to-peer data transfer using two main techniques: 1) stylus NFC sharing—where the NFC wireless connection is used to directly exchange data between the NFC-enabled stylus and another NFC-enabled device; and/or 2) stylus NFC pairing—where the NFC-enabled stylus is used to establish a more capable wireless connection to exchange data with another NFC-enabled device. The more capable wireless connection may allow, for example, faster data transfer rates and/or larger operating distances, such as Bluetooth-based and Wi-Fi-based connections. The different techniques will be discussed in turn and may be referred to collectively herein as stylus data transfer functions.

Stylus NFC sharing is generally useful when exchanging small amounts of data, such as URLs, contact information, or other small files, for three main reasons. First, NFC generally transfers data at slower rates (e.g., 106, 212, or 424 kilobits per second) compared to other wireless communication protocols (e.g., megabits per second or greater). Second, NFC has a smaller operating distance (e.g., about 4 centimeters or less) compared to other wireless communication protocols (e.g., 10 meters for Bluetooth Class 2). And third, NFC-based wireless connections are established automatically and quickly (e.g., less than a tenth of a second) compared to other wireless communication protocols (e.g., multiple steps and for Bluetooth pairing).

For the same three reasons listed above, stylus NFC pairing is useful for establishing a more capable wireless connection Bluetooth-based or Wi-Fi-based), which can then be used to exchange larger files, such as audio and video files, at higher transfer rates and/or more convenient distances. Pairing as used herein, such as in the context of stylus NFC pairing, can include any steps required to establish a more capable wireless connection. For example, stylus NFC pairing in the context of establishing a Bluetooth-based wireless connection may include the steps of enabling Bluetooth, scanning for other devices, initiating pairing, and/or entering the passcode on each device. In another example, stylus NFC pairing in the context of establishing a Wi-Fi-based wireless connection may include the steps of enabling Wi-Fi and/or authenticating a connection between two devices. In some stylus NFC pairing instances, a wireless connection between the stylus and the other NFC-enabled device may be established, as will be apparent in light of this disclosure. In other stylus NFC pairing instances, a wireless connection between a related touch sensitive computing device and the other NFC-enabled device may be established, as will also be apparent. Numerous variations and configurations will be apparent in light of this disclosure.

Device and Stylus Examples

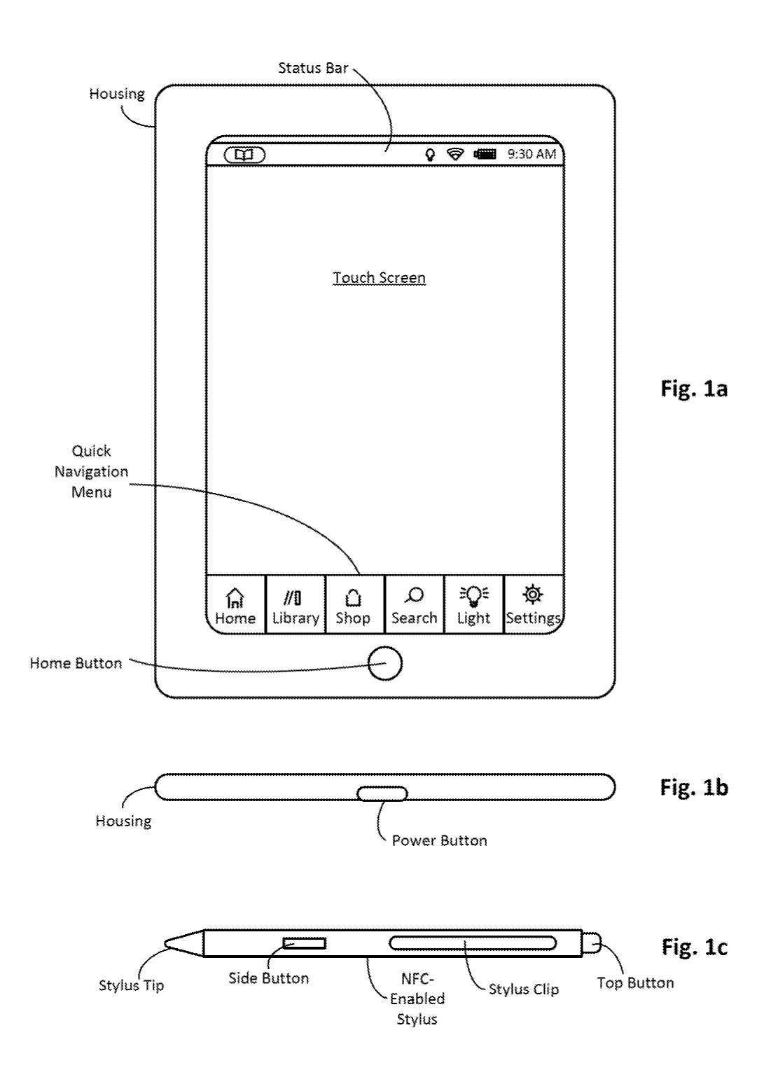

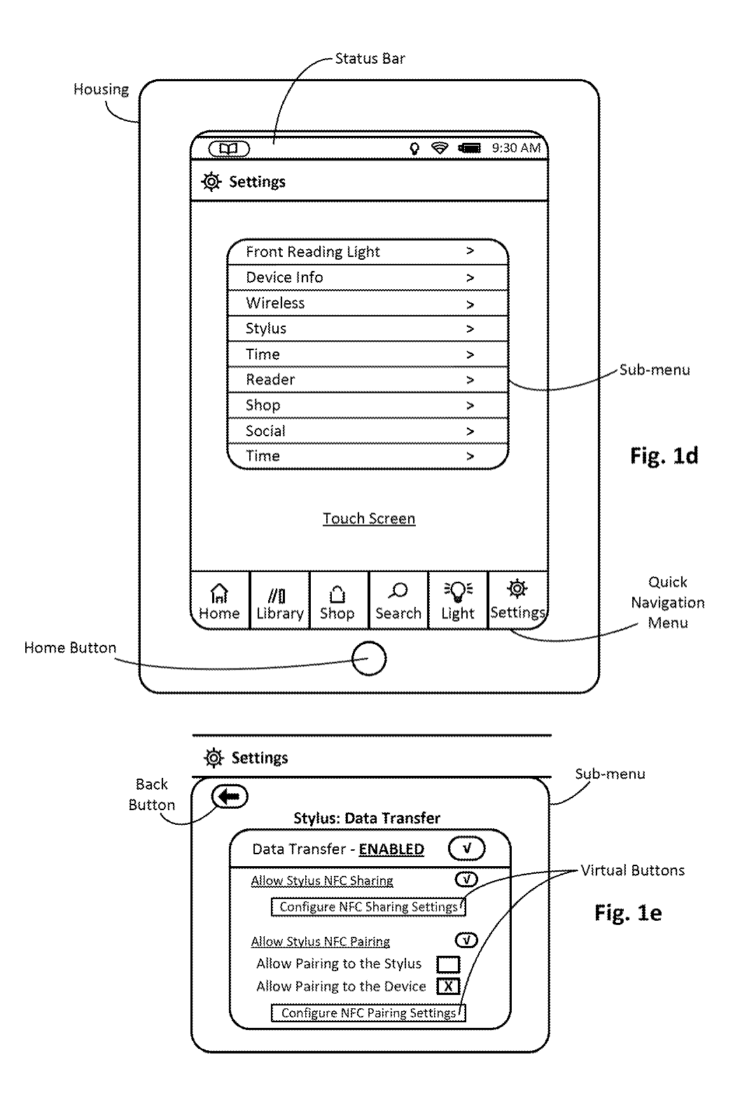

FIGS. 1a-b illustrate an example electronic touch sensitive device capable of being used for stylus data transfer functionality, in accordance with an embodiment of the present invention. The device could be, for example, a tablet such as the NOOK® tablet or eReader by Barnes & Noble. In a more general sense, the device may be any electronic device having a touch sensitive user interface. The device may also have capability for displaying content to a user, such as a mobile phone or mobile computing device such as a laptop, a desktop computing system (with a built-in or separate monitor), a television, a smart display screen, or any other device having a touch screen display or a non-touch display screen that can be used in conjunction with a touch sensitive surface. In a more general sense, the touch sensitive device may comprise of any touch sensitive device capable of data transfer directly or via a stylus with which the device can be paired so as to allow for peer-to-peer data transfer as described herein. As will be appreciated, the claimed invention is not intended to be limited to any particular kind or type of electronic touch sensitive device.

As can be seen with the example configuration shown in FIGS. 1a-b, the device comprises a housing that includes a number of hardware features such as a power button and a press-button (sometimes called a home button herein). A touch screen based user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other touch sensitive devices may have fewer or additional such user interface (UI) touch screen features, or different UI touch screen features altogether, depending on the target application of the device. Any such general UI controls and features can be implemented using any suitable conventional or custom technology, as will be appreciated.

The power button can be used to turn the device on and off and, may be used in conjunction with a touch-based UI control feature that allows the user to confirm a given power transition action request (e.g., such as a slide bar or tap point graphic to turn power off). In this example configuration, the home button is a physical press-button that can be used, for example, to display the quick navigation menu, which is a toolbar that provides quick access to various features of the device. The button may also control other functionality. For instance, holding the button down in a push-and-hold fashion could initiate a searching for stylus function to pair a stylus to the device. In some cases, the home button may be used to facilitate peer-to-peer data transfer using an NFC-enabled stylus, as will be apparent in light of this disclosure.

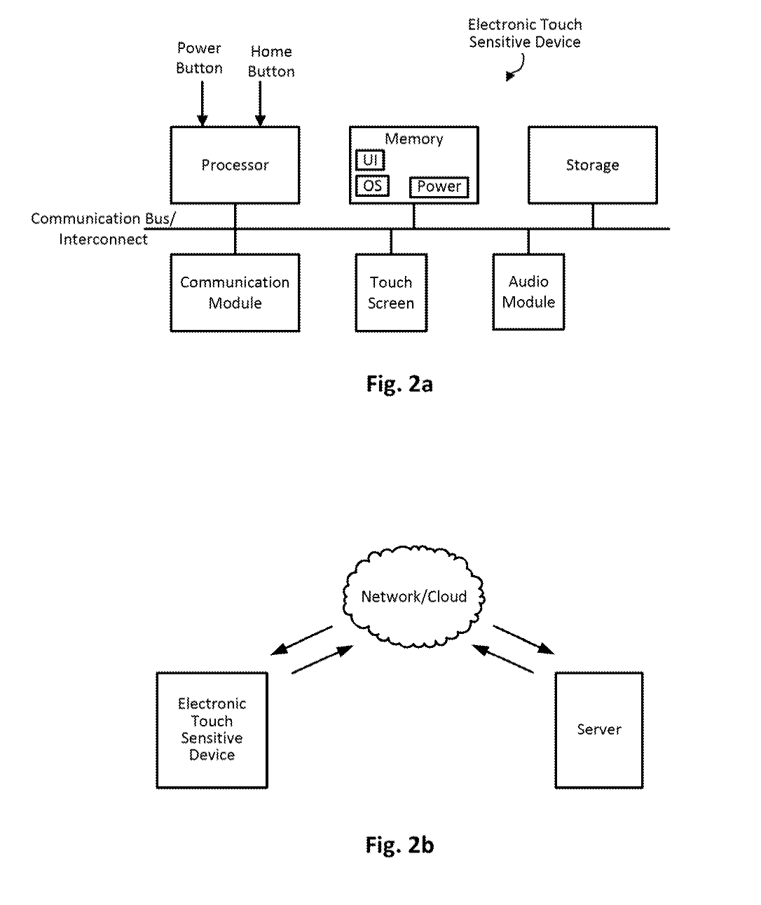

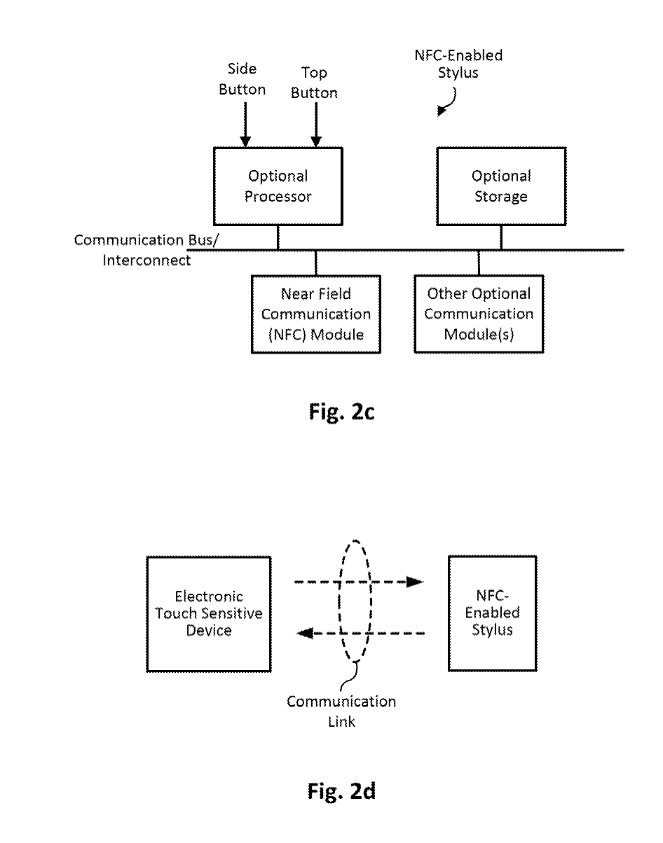

FIG. 1c illustrates an example NFC-enabled stylus for use with an electronic touch sensitive device, in accordance with an embodiment of the present invention. As can be seen, in this particular example, the stylus includes a stylus clip and a stylus tip used to interact with a touch sensitive device, e.g., through direct or proximate contact (i.e., by hovering over the device). In this example, the stylus tip has a triangular shape, while in other examples, the stylus tip may be more rounded, or any other suitable shape. The stylus tip may be made of any number of materials of different textures and firmness depending on the needs of the specific touch sensitive device. This example stylus configuration also includes a side button along the shaft of the stylus and a top button on the end opposite the stylus tip. Example details of the architecture of NFC-enabled styluses used for peer-to-peer data transfer in accordance with one or more embodiments will be discussed in turn with reference to FIG. 2c.

Although the stylus is shown in the example embodiment FIG. 1c as having a top and side button, the stylus may include fewer or additional control features or different control features altogether. The control features may be used in conjunction with the peer-to-peer data transfer function described herein. For example, the top button may be used to enable/disable NFC capabilities and/or to facilitate the exchange of data, as will be apparent in light of this disclosure. In some embodiments, the stylus may have other componentry to aid with the stylus data transfer functionality described herein. For example, some stylus embodiments may include as display (e.g., a light-emitting diode (LED) display) to assist with the data exchange (e.g., allow a user to choose what file(s) to transfer via the peer-to-peer connection). Numerous variations and configurations will be apparent in light of this disclosure.

FIGS. 1d-e illustrate example configuration screen shots of the electronic touch sensitive device shown in FIGS. 1a-b, configured in accordance with an embodiment of the present invention. In one particular embodiment, a Stylus Data Transfer configuration sub-menu, such as the one shown in FIG. 1e, may be accessed by tapping or otherwise selecting the Settings option in the quick navigation menu, which causes the device to display the general sub-menu shown in FIG. 1d. From this general sub-menu the user can select any one of a number of options, including one designated Stylus in this specific example case. Selecting this sub-menu item (with an appropriately placed screen tap) may cause the Stylus Data Transfer configuration sub-menu of FIG. 1e to be displayed, in accordance with an embodiment. In other example embodiments, selecting the Stylus option may present the user with a number of additional sub-options, one of which may include a so-called Data Transfer option, which may then be selected by the user so as to cause the Stylus Data Transfer configuration sub-menu of FIG. 1e to be displayed. Any number of such menu schemes and nested hierarchies can be used, as will be appreciated in light of this disclosure. Note that other embodiments need not be user-configurable and may just have hard-coded functionality. The degree of hard-coding versus user-configurability can vary from one embodiment to the next, and the claimed invention is not intended to be limited to any particular configuration scheme of any kind.

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates the user touch in a given location into an electrical signal which is then received and processed by the underlying operating system (OS) and circuitry (processor, etc.). The user touch may be performed with a finger, a stylus, or any other suitable implement, unless otherwise specified. Additional example details of the underlying OS and circuitry in accordance with one or more embodiments will be discussed in turn with reference to FIG. 2a.

As previously explained, and with further reference to FIGS. 1d and 1e, once the Settings sub-menu is displayed (FIG. 1d), the user can then select the Stylus option. In response to such a selection, the Stylus Data Transfer configuration sub-menu shown in FIG. 1e can be provided to the user. The user can configure a number of options with respect to the stylus data transfer functionality, in this example embodiment. For instance, in this example case, the configuration sub-menu includes a UI check box that when checked or otherwise selected by the user, effectively enables the stylus data transfer functionality (shown in the enabled state); unchecking the box may disable the ability to transfer data from the touch sensitive device using an NFC-enabled stylus, as discussed herein. Other embodiments may have the stylus data transfer functionality always enabled, for example.

In addition, the Stylus Data Transfer sub-menu of this example case includes independent settings options to Allow Stylus NFC Sharing and to Allow Stylus NFC Pairing functionality as described herein. These two options allow a user to enable/disable these two functions (both shown enabled). Further, the Allow NFC Pairing option includes sub-options for choosing whether the NFC-enabled styluses described herein Allow Pairing to the Stylus and/or Allow Pairing to the Device. In other words, in this example case, the user can configure whether the NFC-enabled styluses described herein can be used to pair/establish more capable wireless connections (e.g., Bluetooth-based or Wi-Fi-based) for the stylus itself and/or the related device. The stylus NFC sharing and pairing features may be further configured using the Configure NFC Sharing Settings and Configure NFC Pairing Settings virtual buttons. For example, after selecting the Configure NFC Pairing Settings virtual button, a user may set the wireless connections the NFC-enabled stylus has permission to establish (e.g., Bluetooth-based and/or Wi-Fi-based connections). Numerous other configurable aspects will be apparent in light of this disclosure.

As can be further seen, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Again, while FIGS. 1d and 1e show user configurability, other embodiments may not allow for any such configuration, wherein the various features provided are hard-coded or otherwise provisioned by default.

Architecture

FIG. 2a illustrates a block diagram of an electronic touch sensitive device, configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc.). Further note that although a touch screen display is provided, other embodiments may include a non-touch screen and a touch sensitive surface such as a track pad, or a touch sensitive housing configured with one or more acoustic sensors, etc. In any such cases, the touch sensitive surface is generally capable of translating a user's contact with the surface (whether direct or proximate, as previously described) into an electronic signal that can be manipulated or otherwise used to trigger a specific user interface action, such as those provided herein. The principles provided herein equally apply to any such touch sensitive devices. For ease of description, examples are provided with touch screen technology.

The touch sensitive surface (touch sensitive display in this example) can be any device that is configured with user input detecting technologies, whether capacitive, resistive, acoustic, active or passive stylus, and/or other input detecting technology. The screen display can be layered above input sensors, such as a capacitive sensor grid for passive touch-based input (such as with a finger or passive stylus in the case of a so-called in-plane switching (IPS) panel), or an electromagnetic resonance (EMR) sensor grid (e.g., for sensing a resonant circuit of the stylus). In some embodiments, the touch screen display can be configured with a purely capacitive sensor, while in other embodiments the touch screen display may be configured to provide a hybrid mode that allows for both capacitive input and EMR input. In still other embodiments, the touch screen display is configured with only an active stylus sensor. In any such embodiments, a touch screen controller may be configured to selectively scan the touch screen display and/or selectively report contacts detected directly on or otherwise sufficiently proximate to e.g., within a few centimeters) the touch screen display. Numerous touch screen display configurations can be implemented using any number of known or proprietary screen based input detecting technology,

In one example embodiment, stylus interaction can be provided by, for example, placing the stylus tip on the stylus detection surface, or sufficiently close to the surface (e.g., hovering one to a few centimeters above the surface, or even farther, depending on the sensing technology deployed in the stylus detection surface) but nonetheless triggering a response at the device just as if direct contact were provided on a touch screen display. As will be appreciated in light of this disclosure, an styluses as used herein may be implemented with any number of stylus technologies, such as the technology used in DuoSense® pens by N-trig® (e.g., wherein the stylus utilizes a touch sensor grid of a touch screen display) or EMR-based pens by Wacom technology, or any other commercially available or proprietary stylus technology. Further recall that the stylus sensor in the computing device may be distinct from an also provisioned touch sensor grid in the computing device. Having the touch sensor grid separate from the stylus sensor grid may allow the device to, for example, only scan for a stylus input, a touch contact, or to scan specific areas for specific input sources, in accordance with some embodiments. In one such embodiment, the stylus sensor grid includes a network of antenna coils that create a magnetic field which powers a resonant circuit within the stylus. In such an example, the stylus may be powered by energy from the antenna coils in the device and the stylus may return the magnetic signal back to the device, thus communicating the stylus' location, control feature inputs, etc.

Continuing with the example embodiment shown in FIG. 2a, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C++, objective C JavaScript, custom or proprietary instruction sets, etc.), and encoded on a machine readable medium, that when executed by the processor (and/or co-processors), carries out the functionality of the device including stylus data transfer functionality as described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor 800 MHz Texas Instruments OMAP3621 applications processor), and may include one or more co-processors or controllers to assist in device control. In this example case, the processor receives input from the user, including input from or otherwise derived from the power button and the home button of the device and input from or otherwise derived from the stylus, including input relating to the data transfer function. The processor can also have a direct connection to a battery so that it can perform base level tasks even during sleep or low power modes, such as some or all of the stylus data transfer functionality described herein. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage e.g., for storing consumable content and user files) can also be implemented with any suitable memory and size (e.g., 2 GBytes of flash memory). The display can be implemented, for example, with a 6-inch E-ink Pearl 800×600 pixel screen with Neonode® zForce® touch screen, or any other suitable display and touch screen interface technology.

The communications module can be configured to execute, for instance, any suitable protocol which allows for connection to the stylus to facilitate the stylus data transfer functions described herein. Example communication modules may include NFC, Bluetooth, 802.11 b/g/n WLAN (Wi-Fi), or other suitable chip or chip set that allows for wireless connection to the stylus (including any custom or proprietary protocols). The communication module(s) may be used for stylus NFC sharing functionality as described herein by facilitating the exchange of data with an NFC-enabled device through a related NFC-enabled stylus. The communication module(s) may also be used for direct peer-to-peer data transfer with another NFC-enabled device, e.g., after a related NFC-enabled stylus pairs the two devices using the stylus NFC pairing functionality described herein. In some specific example embodiments, the device housing that contains all the various componentry measures about 6.5″ high by about 5″ wide by about 0.5″ thick, and weighs about 6.9 ounces. Any number of suitable form factors can be used, depending on the target application (e.g., laptop, desktop, mobile phone, etc.). The device may be smaller, for example, for smart phone, eReader, and tablet applications and larger for smart computer monitor applications.

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured, for example, to automatically transition the device to a low power consumption or sleep mode after a period of non-use. The user interface (UI) module can be, for example, based on touch screen technology and the various example screen shots and use-case scenarios demonstrated in FIGS. 1a, 1d-e, 3a-c, 4a-c, and 5a-c along with the NFC-enabled stylus based data transfer methodologies shown in FIG. 6. The audio module can be configured, for example, to speak or otherwise aurally present information related to the stylus data transfer functionality or other virtual content, if preferred by the user. Numerous commercially available text-to-speech modules can be used to facilitate the aural presentation of the information, such as Verbose text-to-speech software by NCH Software. In some example cases, if additional space is desired, for example, to store the data exchanged during peer-to-peer data transfer as described herein or other content, storage can be expanded via a microSD card or other suitable memory expansion technology (e.g., 32 GBytes, or higher). Further note that although a touch screen display is provided, other embodiments may include a non-touch screen and a touch sensitive surface such as a track pad, or a touch sensitive housing configured with one or more acoustic sensors, etc.

FIGS. 2b illustrates a block diagram of a communication system including the electronic touch sensitive device of FIG. 2a, configured in accordance with an embodiment of the present invention. As can be seen, the system generally includes an electronic touch sensitive device that is capable of communicating with a server via a network/cloud. In this example embodiment, the electronic touch sensitive device may be, for example, an eReader, a smart phone, a laptop, a tablet, a desktop computer, or any other electronic touch sensitive computing device. The network/cloud may be a public and/or private network, such as a private local area network (e.g., home cloud) operatively coupled to a wide area network such as the Internet. In this example embodiment, the server may be programmed or otherwise configured to receive content requests from a user via the touch sensitive device and to respond to those requests by providing the user with requested or otherwise recommended content. In some such embodiments, the server may be configured to remotely provision the stylus data transfer functionality and/or the data being exchanged as provided herein to the touch sensitive device (e.g., via JavaScript or other browser based technology). In other embodiments, portions of the methodology are executed on the server and other portions of the methodology are executed on the device. Numerous server-side/client-side execution schemes can be implemented to facilitate the stylus data transfer functionality in accordance with an embodiment as will be apparent in light of this disclosure.

FIG. 2c illustrates a block diagram of an example NFC-enabled stylus for use with an electronic touch sensitive device, configured in accordance with an embodiment of the present invention. As can be seen, this example stylus includes an NFC module, other optional communication module(s), a side button, and a top button. A communications bus and interconnect may be provided to allow inter-device communication. A processor may also be included in the stylus to provide local intelligence, but such is not necessary in embodiments where the touch sensitive device with which the stylus is communicatively coupled provides the requisite control and direction, including whether to allow and/or initiate stylus data transfer functionality. Memory and/or storage may also be included in the stylus, for example, for storing user data exchanged during peer-to-peer data transfer with other NFC-enabled devices. Other componentry and functionality not reflected in the block diagram will be apparent (e.g., battery, speaker, antenna, display, etc.). The processor can be any suitable processor and may be programmed or otherwise configured to assist in controlling the stylus, and may receive input from the user from control features, including the side and top buttons. The memory/storage may be implemented with any suitable memory and size (e.g., 2 to 4 GBytes of flash memory).

The NFC module used for stylus data transfer functionality as described herein operates in active mode to allow for peer-to-peer data transfer via stylus NFC sharing and/or stylus NFC pairing. Since the NFC module is operating in active mode to perform the stylus data transfer functions described herein, it must be powered, for example, by a battery. The peer-to-peer mode is standardized on the ISO/IEC 18092 standard and typically operates at 13.56 MHz. NFC has a working distance of up to 20 cm; however, it has a more practical working distance of up to 4 cm. As previously described, the NFC module automatically detects and initiates communication with other NFC-enabled devices when the NFC-enabled stylus is within the particular working distance of other NFC-enabled devices. In some embodiments, the NFC-enabled stylus of FIG. 2c may need to physically touch another NFC-enabled device to initiate stylus NFC sharing and/or pairing as described herein (or the working distance may be so small that it may appear that a physical touch is needed). Example NFC data transfer rates range from 106 kbit/s to 424 kbit/s, and may be higher in some instances, such as 848 kbit/s. The NFC module may use various conventional specifications or protocols, such as a Simple NDEF Exchange Protocol (SNEP) and/or Logical Link Control Protocol (LLCP), to facilitate peer-to-peer data transfer. The NFC module may also include an NFC controller and/or NFC controller interface (NCI).

In some instances, the NFC-enabled styluses described herein may only include an NFC module, which can be used to communicate with a related touch sensitive device (e.g., to exchange the user data before, during, or after peer-to-peer data transfer) and other NFC-enabled devices. However, some stylus embodiments may contain other optional communication module(s), such as Bluetooth, Wi-Fi, or any other suitable wireless communication module. In instances where the stylus includes one or more other optional communication modules, the communication module(s) (e.g., Bluetooth and/or Wi-Fi) may be used to exchange data between the NFC-enabled stylus and a related touch sensitive device during stylus NFC sharing. The other communication module(s) may also be used to exchange data with the related touch sensitive device before and/or after stylus NFC sharing (e.g., where the stylus stores the data being exchanged). In some other instances, the communication module(s) may be used to exchange data after a stylus NFC pairing function establishes a wireless connection using one of the other optional communication modules (e.g., Bluetooth-based and/or Wi-Fi-based). The communication modules may also be used to receive input from control features, such as the side button and top button of the stylus, and to then transmit the input to other modules or devices.

FIG. 2d illustrates a block diagram showing a communication link between the electronic touch sensitive device of FIG. 2a and the stylus of FIG. 2c, according to an embodiment of the present invention. As can be seen, the system generally includes an electronic touch sensitive device that is capable of wirelessly connecting to other devices and an NFC-enabled stylus that is also capable of wirelessly connecting to other devices. In this example embodiment, the electronic touch sensitive device may be, for example, an eReader, a smart phone, a laptop, a tablet, a desktop computer, or any other touch sensitive computing device. Conventional or custom discovery and handshake protocols can be used to introduce or otherwise relate a given NFC-enabled stylus with a given touch sensitive device, in accordance with some embodiments, prior to initiating the communication link shown in FIG. 2d or the stylus data transfer functionality described herein. In some such cases, a software driver that comes with the stylus can be loaded onto the target electronic device, so as to enable the communication between the device and stylus as well as the functionality described herein. Such plug and play functionality can be implemented using any number of suitable self-discovery based communication protocols.

As described above, the communication link may include an NFC, Bluetooth, 802.11 b/g/n WLAN (Wi-Fi), or other suitable communication link which allows for the transfer of data between the electronic touch sensitive device and the NFC-enabled stylus. For example, after a communication link is established (e.g., via a Bluetooth connection), that link may be used to exchange data to the stylus during peer-to-peer data transfer or other various information relating to the stylus data transfer functionality described herein. In other example embodiments, the stylus may communicate with the electronic touch sensitive device through a cloud/network to send signals relating the stylus data transfer functions indirectly to the device. For example, the stylus may connect to a Wi-Fi or cellular network and communicate with a related touch sensitive device through that network. Numerous variations and configurations will be apparent in light of this disclosure.

Example Stylus Data Transfer Functions

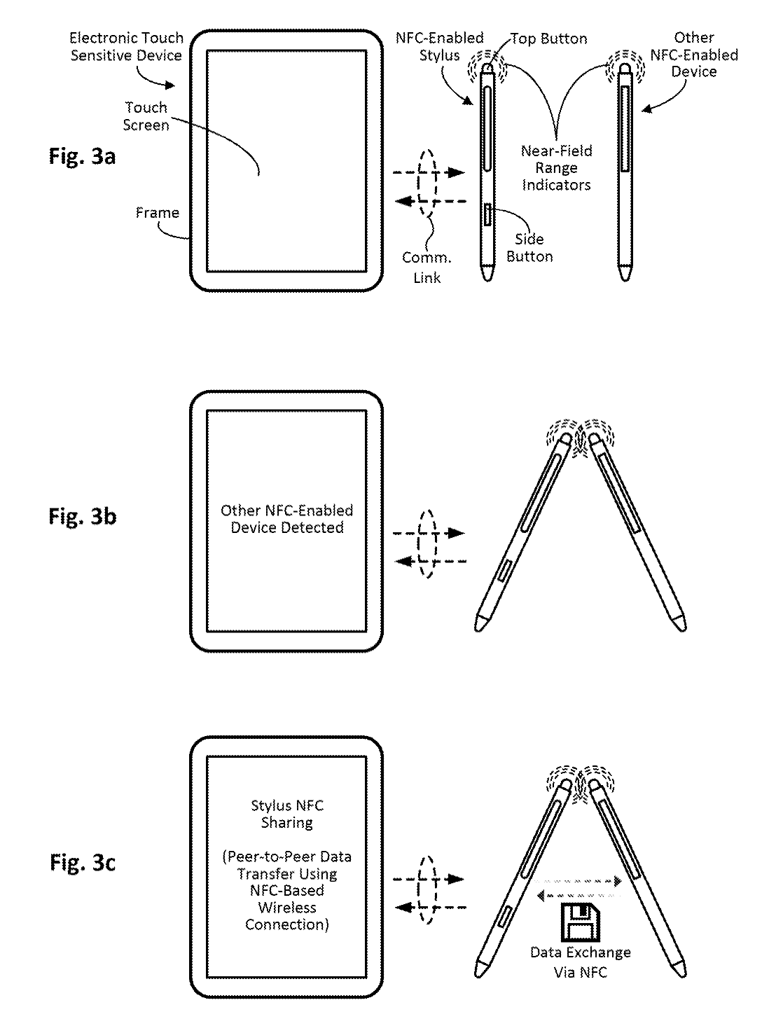

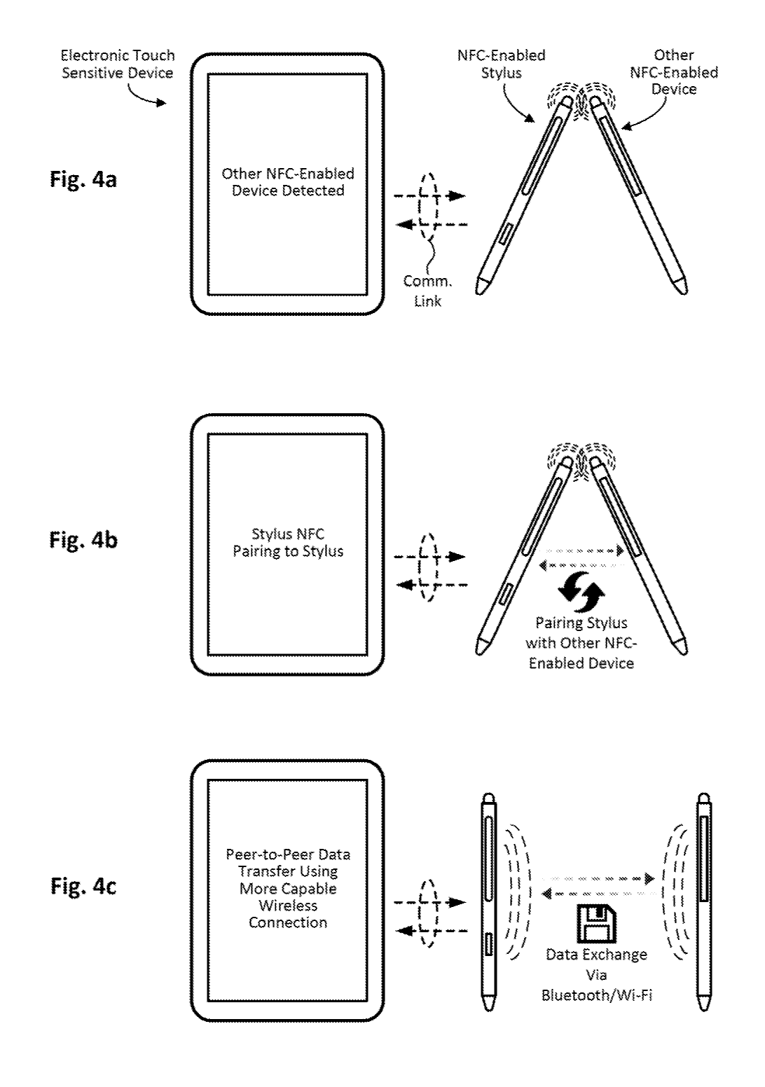

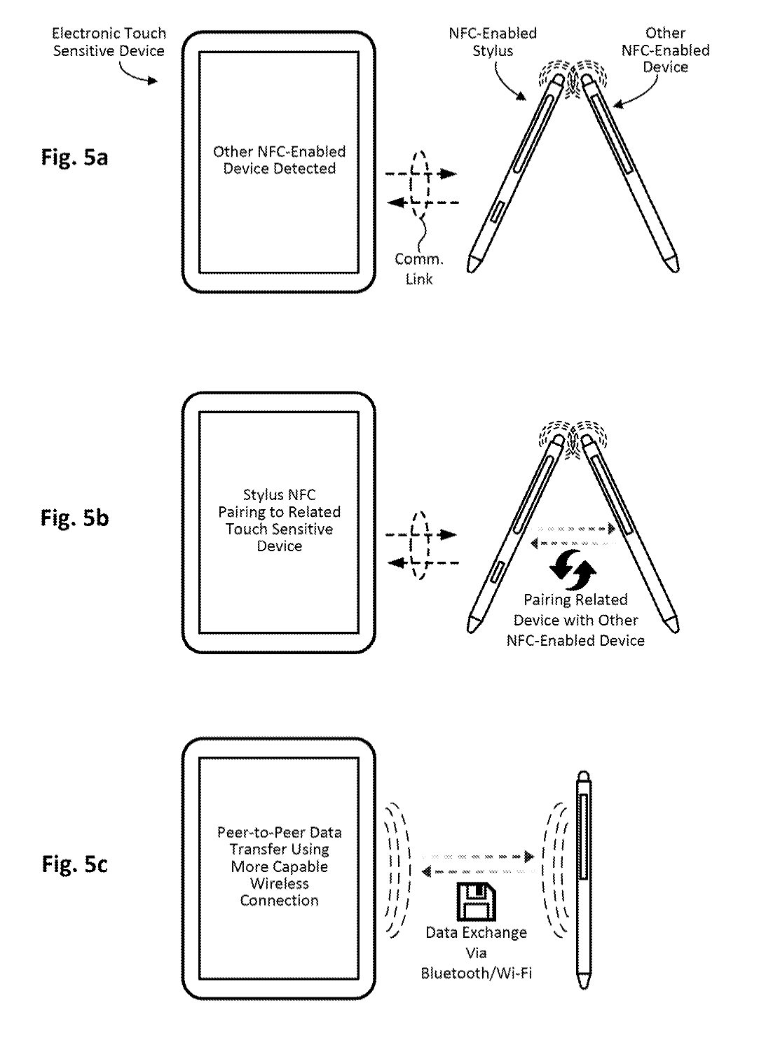

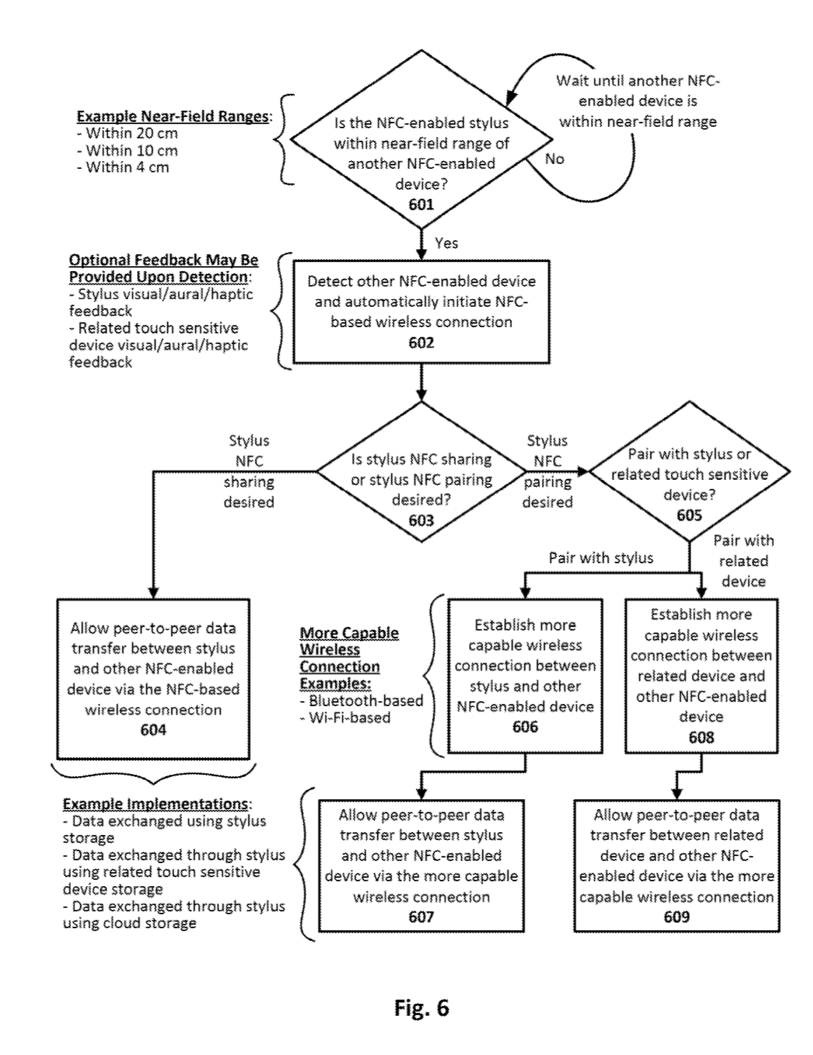

As an overview, FIGS. 3a-c illustrate example stylus NFC sharing functionality in accordance with an embodiment, FIGS. 4a-c illustrate example stylus NFC pairing to stylus functionality in accordance with an embodiment, and FIGS. 5a-c illustrate example stylus NFC pairing to related touch sensitive device functionality in accordance with an embodiment. All three of these example functions use an NFC-enabled stylus to establish wireless connections for enabling peer-to-peer data transfer. Although the examples shown in FIGS. 3-5 illustrate stylus NFC sharing and pairing with only one other NFC-enabled device (specifically, another NFC-enabled stylus), the same techniques can be used to allow peer-to-peer data transfer with multiple other NFC-enabled devices simultaneously (e.g., NFC sharing data transfer to two or more other NFC-enabled styluses at the same time).

FIGS. 3a-c illustrate an example stylus NFC sharing function using an NFC-enabled stylus, in accordance with an embodiment of the present invention. Generally: FIG. 3a shows an electronic touch sensitive device, an NFC-enabled stylus (having a communication link with the related electronic touch sensitive device), and another NFC-enabled device (specifically another NFC-enabled stylus, in this example case); FIG. 3b shows the NFC-enabled stylus within near-field range of the other NFC-enabled device; and FIG. 3c shows a stylus NFC sharing function where the NFC-enabled stylus and other NFC-enabled device can exchange data via a NFC-based wireless connection. As previously described, a stylus is being shown for the other NFC-enabled device for illustrative purposes; however, the other NFC-enabled device, as used herein, can be computer, tablet, smart phone, eReader, projector, printer, camera, game controller, or any other suitable NFC-enabled device.

As can be seen in FIG. 3a, a physical frame or support structure is provided about the touch screen of the electronic tough sensitive device. The electronic touch sensitive device, as used herein, may be a smart phone, eReader, tablet, or any other electronic touch sensitive device. The NFC-enabled stylus is shown having a communication link (e.g., see FIG. 2d) with the related touch sensitive device. The communication link, as used herein, may be established using conventional or custom discovery and handshake protocols as was previously described. The communication link may be NFC-based, Bluetooth-based, or Wi-Fi-based, for example. The NFC-enabled stylus has an NFC module which allows the stylus to communicate with other NFC-enabled devices when they enter a near-field range. As previously described, the near-field range may be up to 20 cm, 10 cm, 4 cm, or some other suitable near-field distance. The other NFC-enabled device is also shown in FIG. 3a and near-field range indicators for the NFC-enabled stylus and other NFC-enabled device are shown for illustrative purposes. The NFC-enabled stylus shown in this example embodiment has a top button and side button.

FIG. 3b shows the other NFC-enabled device entering the near-field range of the NFC-enabled stylus. Once the other NFC-enabled device enters the near-field range of the NFC-enabled stylus, stylus, the other NFC-enabled device is detected and an NFC-based wireless connection is automatically initiated. In some embodiments, an actual physical touch or apparent physical touch (e.g., where the near-field range is less than 4 cm) may be required to detect the other NFC-enabled device. The location of the NFC module in the NFC-enabled stylus and/or the other NFC-enabled device, as well as the respective near-field ranges of the two NFC-enabled devices may affect the distance and/or location requirements for NFC-based wireless connections. As can be seen in this embodiment, the near-field ranges of the NFC-enabled styluses emanate from the top of the styluses such that the tops of the styluses have to come into close proximity to initiate an NFC connection.

In some embodiments, when another NFC-enabled device is detected by the NFC-enabled stylus, the stylus and/or the related touch sensitive device may be configured to provide feedback to notify a user of the detection. The detection feedback may be visual (e.g., a multi-colored light-emitting diode (LED) on the stylus turns green), aural (e.g., a speaker in the stylus makes a detection sound, and/or haptic (e.g., the stylus vibrates using an eccentric weight and motor). In this example case, the related touch sensitive device shown in FIG. 3b is providing visual feedback by displaying text indicating that another NFC-enabled device has been detected after such a detection is transmitted to the related device via the communication link. Feedback may also be provided to indicate: a wireless connection has been established, data was transmitted, data was received, and/or the wireless connection has been disconnected.

FIG. 3c shows the stylus NFC sharing function that allows peer-to-peer data transfer using the NFC-based wireless connection. In some instances, the wireless connection for peer-to-peer data transfer may be automatically established, for example, after the NFC-enabled stylus and other NFC-enabled device are within the appropriate near-field range. In other instances, additional actions may be required to allow (or execute) peer-to-peer data transfer, such as pressing the top button on the NFC-enabled stylus when the other NFC-enabled device is within range. Once peer-to-peer data transfer has been enabled via the NFC-based wireless connection, data can be exchanged via the NFC connection. Since the wireless connection is NFC-based, the stylus and other device have to stay within near-field range to maintain the peer-to-peer connection for data exchange.

The stylus NFC sharing function implementation may depend upon the storage location of the data exchanged via NFC. In an example case, if the storage used for the data exchanged via NFC is on the stylus itself, then automatic exchange may occur by bringing the stylus within near-field range of another NFC-enabled device; however, the sharing function may require additional steps, such as the manipulation of one or more control features (e.g., pressing the top button of the stylus) in order to exchange data. In this example case, the data being transferred from the stylus during data exchange via NFC (i.e., data sent to the other NFC-enabled device) can be preliminarily transferred to the stylus from the related device via the communication link. Further, in this example case, the data being transferred to the stylus during data exchange via NFC data received from the other NFC-enabled device) can be subsequently transferred from the stylus to the related device via the communication link. Therefore, in some instances, the communication link between the NFC-enabled stylus and related touch sensitive device does not need to be maintained during the data exchange. In another embodiment, the stylus may include a display, such as an LED display, to facilitate the data exchange. For example, if the stylus is storing multiple files, such as multiple documents, the display may allow a user to determine what specific documents to exchange via NFC sharing. As previously described, the sharing may occur with more than one other NFC-enabled device, for example. Where multiple other NFC-enabled devices are within near-field range of the stylus when sharing.

In another example case, if data exchanged via NFC sharing is stored on the related touch sensitive device, then additional steps may be needed to transfer data with the other NFC-enabled device. For example, a user may decide what data to exchange using the touch sensitive device while the peer-to-peer data transfer between the stylus and other NFC-enabled device is enabled. In this example, the data exchanged will occur through the NFC-enabled stylus using the communication link with the related touch sensitive device (with the stylus acting as a hub). In this manner, a user can determine what data will be exchanged either before the NFC-enabled stylus gets within near-field range of the other NFC-enabled device, or while the stylus and other device are within near-field range. Alternatively, the data being exchanged may be stored in cloud storage accessed by the related touch sensitive device or just the stylus itself (e.g., if the stylus is connected to the cloud storage via a Wi-Fi or cellular network).

FIGS. 4a-c illustrate an example stylus NFC pairing to stylus function using an NFC-enabled stylus, in accordance with an embodiment of the present invention. Generally: FIG. 4a shows an electronic touch sensitive device, an NFC-enabled stylus (having a communication link with the related electronic touch sensitive device), and another NFC-enabled device within near-field range of the stylus; FIG. 4b shows a stylus NFC pairing function to pair the NFC-enabled stylus with the other NFC-enabled device to establish a more capable wireless connection; and FIG. 4c shows the NFC-enabled stylus and other NFC-enabled device paired via a more capable wireless connection (e.g., Bluetooth-based or Wi-Fi-based) for peer-to-peer data transfer. As was previously described, the more capable wireless connection may include any wireless connection that provides a faster data transfer rate and/or a larger operating distance than the NFC-based wireless connection used to pair/setup/configure the more capable wireless connection (e.g., Bluetooth or Wi-Fi). As was also described stylus NFC pairing can include any steps required to establish the more capable wireless connection.

FIG. 4a shows the other NFC-enabled device entering the near-field range of the NFC-enabled stylus to establish an NFC-based wireless connection, as occurred in FIG. 3b. FIG. 4b shows the NFC-based wireless connection being used for a stylus NFC pairing function used to pair the NFC-enabled stylus with the other NFC-enabled device. For example, stylus NFC pairing to the stylus in the context of establishing a Bluetooth-based wireless connection may include the steps of enabling Bluetooth on the stylus, scanning for the other NFC-enabled device, initiating pairing, and/or entering the passcode on the stylus and device. In another example, stylus NFC pairing to the stylus in the context of establishing a Wi-Fi-based wireless connection may include the steps of enabling Wi-Fi on the stylus and/or authenticating a connection between the stylus and other NFC-enabled device. Once the more capable wireless connection is established between the NFC-enabled stylus and the other NFC-enabled device, that more capable wireless connection can be used to allow peer-to-peer data transfer between the NFC-enabled stylus and other NFC-enabled device, as shown in FIG. 4c. This peer-to-peer data transfer is similar to the peer-to-peer data transfer described with reference to FIG. 3c (i.e., the storage location of the data may affect the implementation, etc.), except in this case, the NFC-enabled stylus and other NFC-enabled device may not have to stay within near-field range since the data exchange is via a more capable wireless connection (such as Bluetooth-based or Wi-Fi-based).

FIGS. 5a-c illustrate an example stylus NFC pairing to related touch sensitive device function using an NFC-enabled stylus, in accordance with an embodiment of the present invention. Generally: FIG. 5a shows an electronic touch sensitive device, an NFC-enabled stylus (having a communication link with the related electronic touch sensitive device), and another NFC-enabled device within near-field range of the stylus; FIG. 5b shows a stylus NFC pairing function to pair the related touch sensitive device with the other NFC-enabled device to establish a more capable wireless connection between the devices; and FIG. 5c shows the touch sensitive device and other NFC-enabled device paired via a more capable wireless connection (e.g., Bluetooth-based or Wi-Fi-based) for peer-to-peer data transfer. The stylus NFC pairing to related touch sensitive device function is similar to the stylus NFC pairing to stylus function, except that the NFC-enabled stylus is being used to instead pair its related touch sensitive device with the other NFC-enabled device.

FIG. 5a shows the other NFC-enabled device entering the near-field range of the NFC-enabled stylus to establish an NFC-based wireless connection, as occurred in FIGS. 3b and 4a. FIG. 5b shows the NFC-based wireless connection being used for a stylus NFC pairing function used to pair the related touch sensitive device with the other NFC-enabled device. For example, stylus NFC pairing to the related device in the context of establishing a Bluetooth-based wireless connection may include the steps of enabling Bluetooth on the related device, scanning for the other NFC-enabled device, initiating pairing, and/or entering the passcode on the related device and other NFC-enabled device. In another example, stylus NFC pairing to the related device in the context of establishing a Wi-Fi-based wireless connection may include the steps of enabling Wi-Fi on the related device and/or authenticating a connection between the related device and the other NFC-enabled device. Once the more capable wireless connection is established between the related touch sensitive device and the other NFC-enabled device, that more capable wireless connection can be used to allow peer-to-peer data transfer between the related device and other NFC-enabled device, as shown in FIG. 5c. The peer-to-peer data transfer allows for data exchange between the other NFC-enabled device and the electronic touch sensitive device via the more capable wireless connection (such as Bluetooth-based or Wi-Fi-based). In the example case shown in FIG. 5c, the NFC-enabled stylus may not be required for the peer-to-peer data transfer once its related touch sensitive device and the other-NFC enabled device have been paired.

Methodology

FIG. 6 illustrates a method for stylus data transfer using an NFC-enabled stylus, in accordance with one or more embodiments of the present invention. The NFC-enabled stylus is intended to interact with a related touch sensitive device as described herein. The related device may be a smart phone, eReader, tablet, or any other suitable electronic touch sensitive device. This example methodology may be implemented, by an NFC-enabled stylus (e.g., see FIGS. 1c and 2c), a related touch sensitive device (e.g., see FIGS. 1a-b and 2a), or some combination thereof, depending upon the specific implementation of the stylus data transfer function. To this end, the stylus data transfer functionality can be implemented in any combination of software, hardware, and firmware. In one specific embodiment, the UI module of the electronic computing device is configured to carry out or otherwise direct the methodology. However, as will be appreciated, the UI module may be distributed in nature, wherein some is executed by the device and some by the stylus, for instance. In still other embodiments, the stylus is configured to carry out or otherwise direct the methodology. Numerous such configurations will be apparent in light of this disclosure.

As can be seen, in this example case, the method starts by determining whether an NFC-enabled stylus (used to interact with a related touch sensitive device) is within near-field range of another NFC-enabled device 601. It is to be understood that the other NFC-enabled device is distinct from the touch sensitive device related to the NFC-enabled stylus as described herein, even though the related device may be NFC-enabled and the stylus and related device may communicate via NFC. Example near-field ranges may include when another NFC-enabled device is within 20 cm, 10 cm, or 4 cm, although other suitable near-field ranges may be used. If another NFC-enabled device is not within near field range of the NFC-enabled stylus, then the method waits until another NFC-enabled device is within near-field range. Once another NFC-enabled device is within near-field range of the NFC-enabled stylus, then the other NFC-enabled device is detected and an NFC-based wireless connection is automatically initiated 602. Optional feedback may be provided upon detection of the other NFC-enabled device to notify that the other NFC-enabled has been detected and/or to notify that an NFC-based wireless connection has been established, with that other NFC-enabled device. The feedback may include visual, aural, and/or haptic feedback from the stylus and/or related touch sensitive device, as described herein.

After the other NFC-enabled device is detected and an NFC-based wireless connection is initiated between the stylus and other device, it is determined whether stylus NFC sharing or stylus NFC pairing is desired 603. This determination can be made in various ways. For example, in some embodiments, stylus NFC sharing or pairing, or some portion of these functions, may not be available and/or enabled (e.g., see FIG. 1e where the user can independently enable/disable the two functions and portions thereof). Therefore, the available stylus data transfer function options may be limited at the onset. If stylus NFC sharing and pairing functions are both fully available, then a user may select a desired stylus NFC sharing or pairing function prior to, during, or after the initiation of the wireless connection between the NFC-enabled stylus and the other NFC-enabled device 602. The functionality may also depend upon the specifications of the NFC-enabled stylus, the related touch sensitive device, and/or the other NFC-enabled device. For example, if the stylus only includes an NFC module and no other communication module, then stylus NFC pairing to establish a more capable wireless connection between the stylus and other NFC-enabled device would not be possible steps 606-607 would not be possible, as will be apparent). The function may also depend upon the application or service being used for peer-to-peer data transfer. For example, the application may only be compatible with Wi-Fi-based connections, thus the application may automatically establish or require a Wi-Fi-based connection in order to properly allow peer-to-peer data transfer.

Continuing with the method shown in FIG. 6, if stylus NFC sharing is desired, then the NFC-based wireless connection established in 602 is used to allow peer-to-peer data transfer between the stylus and the other NFC-enabled device via the NFC-based wireless connection 604. In other words, in the case of stylus NFC sharing, after the NFC connection is established 602, data can be exchanged between the stylus and other device via that NFC connection 604. As previously explained, the data exchanged during peer-to-peer data transfer may be stored with the stylus, with the related touch sensitive device, or in cloud storage, depending upon the specific implementation. Therefore, in the case of stylus NFC sharing, peer-to-peer data transfer with the other NFC-enabled device may be exchanged just with the stylus, or through the stylus where the stylus acts as a hub for the related device or cloud storage, as is apparent in light of this disclosure.

If stylus NFC pairing functionality is desired, then it is determined whether the other NFC-enabled device is to be paired with the stylus or the related touch sensitive device 605. If stylus NFC pairing is being used to pair the other NFC-enabled device and the stylus, then the NFC connection from 602 can be used to establish a more capable wireless connection between the stylus and other NFC-enabled device 606, such as Bluetooth-based or Wi-Fi-based connection. The more capable wireless connection can then be used to allow peer-to-peer data transfer between the stylus and the other NFC-enabled device 607. As was the case with stylus NFC sharing, the data exchanged during peer-to-peer data transfer between the stylus and other NFC-enabled device may be stored with the stylus, with the related touch sensitive device, or in cloud storage, depending upon the specific implementation. If stylus NFC pairing is being used to pair the other NFC-enabled device and the related touch sensitive device, then the NFC connection from 602 can be used to establish a more capable wireless connection between the related device and the other NFC-enabled device 608, such as a Bluetooth-based or Wi-Fi based connection. The more capable wireless connection can then be used to allow peer-to-peer data transfer between the related device and the other NFC-enabled device 609.

Numerous variations and embodiments will be apparent in light of this disclosure. One example embodiment of the present invention provides a stylus including an elongated body portion having a stylus tip for interacting with an electronic touch sensitive device. The stylus also includes a near field communication (NFC) module capable of establishing a wireless connection with another NFC-enabled device, wherein the wireless connection allows peer-to-peer data transfer. In some cases, the wireless connection allows peer-to-peer transfer of documents, presentations, lectures, notes, messages, photos, audio files, videos, contact information, applications, games, uniform resource locators (URLs), website links, and/or stylus customizations. In some cases, the wireless connection is NFC-based, Bluetooth-based or Wi-Fi-based. In some cases, the wireless connection is established by at least bringing the stylus within 4 centimeters of the other NFC-enabled device and/or physically touching the stylus to the other NFC-enabled device. In some cases, the stylus includes storage accessible during peer-to-peer data transfer. In some cases, the other NFC-enabled device is a stylus, computer, tablet, smart phone, eReader, projector, printer, camera, or game controller.

Another example embodiment of the present invention provides a system including a touch sensitive computing device, and a stylus for interacting with the touch sensitive computing device. In this example embodiment, the stylus has near field communication (NFC) capabilities for establishing a wireless connection with another NFC-enabled device, wherein the wireless connection allows peer-to-peer data transfer. In some cases the other NFC-enabled device is a stylus, computer, tablet, smart phone, eReader, projector, printer, camera, or game controller. In some cases, the touch sensitive computing device is configured to wirelessly communicate with the stylus to facilitate peer-to-peer data transfer between the stylus and the other NFC-enabled device. In some cases, the stylus is capable of establishing a wireless connection between the touch sensitive computing device and the other NFC-enabled device to allow peer-to-peer data transfer between the touch sensitive computing device and the other NFC-enabled device. In some cases, the system is user-configurable. In some cases, the wireless connection is NFC-based, Bluetooth-based or Wi-Fi-based. In some cases, the stylus and/or touch sensitive computing device provides visual, aural, and/or haptic feedback when the stylus detects the other NFC-enabled device, the wireless connection is established, data is transferred, and/or the wireless connection is disconnected.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to establish a wireless connection (in response to a near field communication (NFC)-enabled stylus used for interacting with an electronic touch sensitive device entering a near-field range of another NFC-enabled device), and allow peer-to-peer data transfer via the wireless connection. In some cases, the wireless connection allows peer-to-peer transfer of documents, presentations, lectures, notes, messages, photos, audio files, videos, contact information, applications, games, uniform resource locators (URLs), website links, and/or stylus customizations. In some cases, the near-field range is within 4 centimeters. In some cases, the wireless connection is NFC-based, Bluetooth-based, or Wi-Fi-based. In some cases, the wireless connection is established between the NFC-enabled stylus and the other NFC-enabled device. In some cases, the process is configured to pair the NFC-enabled stylus with the touch sensitive device to facilitate peer-to-peer data transfer between the stylus and other NFC-enabled device. In some cases, the wireless connection is established between a touch sensitive computing device associated with the NFC-enabled stylus and the other NFC-enabled device.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A stylus comprising:
an elongated body portion having a stylus tip for interacting with an electronic touch sensitive device; and
a near field communication (NFC) module capable of establishing a wireless connection with another NFC-enabled device, wherein the wireless connection allows peer-to-peer data transfer.

2. The stylus of claim 1 wherein the wireless connection allows peer-to-peer transfer of documents, presentations, lectures, notes, messages, photos, audio files, videos, contact information, applications, games, uniform resource locators (URLs), website links, and/or stylus customizations.

3. The stylus of claim 1 wherein the wireless connection is NFC-based, Bluetooth-based, or Wi-Fi-based.

4. The stylus of claim 1 wherein the wireless connection is established by at least bringing the stylus within 4 centimeters of the other NFC-enabled device and/or physically touching the stylus to the other NFC-enabled device.

5. The stylus of claim 1 further comprising storage accessible during peer-to-peer data transfer.

6. The stylus of claim 1 wherein the other NFC-enabled device is a stylus, computer, tablet, smart phone, eReader, projector, printer, camera, or game controller.

7. A system comprising:
a touch sensitive computing device; and
a stylus for interacting with the touch sensitive computing device, the stylus having near field communication (NFC) capabilities for establishing a wireless connection with another NFC-enabled device, wherein the wireless connection allows peer-to-peer data transfer.

8. The stylus of claim 7 wherein the other NFC-enabled device is a stylus, computer, tablet, smart phone, eReader, projector, printer, camera, or game controller.

9. The system of claim 7 wherein the touch sensitive computing device is configured to wirelessly communicate with the stylus to facilitate peer-to-peer data transfer between the stylus and the other NFC-enabled device.

10. The system of claim 7 wherein the stylus is capable of establishing a wireless connection between the touch sensitive computing device and the other NFC-enabled device to allow peer-to-peer data transfer between the touch sensitive computing device and the other NFC device.

11. The system of claim 7 wherein the system is user-configurable.

12. The system of claim 7 wherein the wireless connection is NFC-based, Bluetooth-based, or Wi-Fi-based.

13. The system of claim 7 wherein the stylus and/or touch sensitive computing device provides visual, aural, and/or haptic feedback when the stylus detects the other NFC-enabled device, the wireless connection is established, data is transferred, and/or the wireless connection is disconnected.

14. A computer program product comprising a plurality of instructions non-transiently encoded thereon to facilitate operation of an electronic device according to the following process, the process comprising:
in response to a near field communication (NFC)-enabled stylus used for interacting with an electronic touch sensitive device entering a near-field range of another NFC-enabled device, establish a wireless connection; and
allow peer-to-peer data transfer via the wireless connection.

15. The computer program product of claim 14 wherein the wireless connection allows peer-to-peer transfer of documents, presentations, lectures, notes, messages, photos, audio files, videos, contact information, applications, games, uniform resource locators (URLs), website links, and/or stylus customizations.

16. The computer program product of claim 14 wherein the near-field range is within 4 centimeters.

17. The computer program product of claim 14 wherein the wireless connection is NFC-based, Bluetooth-based, or Wi-Fi-based.

18. The computer program product of claim 14 wherein the wireless connection is established between the NFC-enabled stylus and the other NFC-enabled device.

19. The computer program product of claim 18, the process further comprising:
pair the NFC-enabled stylus with the touch sensitive device to facilitate peer-to-peer data transfer between the stylus and other NFC-enabled device.

20. The computer program product of claim 14 wherein the wireless connection is established between a touch sensitive computing device associated with the NFC-enabled stylus and the other NFC-enabled device.
